(19) United States
(12) Patent Application Publication
(10) Pub. No.: US 2022/0358405 A1
(43) Pub. Date: Nov. 10, 2022

(54) System and Method for Generating Artificial Intelligence Driven Insights

(71) Applicant: STATS LLC, Chicago, IL (US)

(72) Inventors: Paul Every, London (GB); Jimmy Coverdale, Limerick (IE); Christian Marko, Graz (AT); Yadir Lakehal, New York, NY (US); Patrick Joseph Lucey, Chicago, IL (US)

(73) Assignee: STATS LLC, Chicago, IL (US)

(21) Appl. No.: 17/662,044

(22) Filed: May 4, 2022

Related U.S. Application Data
(60) Provisional application No. 63/201,529, filed on May 4, 2021.

(51) Int. Cl. G06N 20/00

(52) U.S. Cl. CPC G06N 20/00

(57) ABSTRACT

A computing system receives event data for a game. The computing system generates a plurality of artificial intelligence driven metrics based on the event data. The computing system generates a plurality of insights via one or more machine learning models based on the event data and the plurality of artificial intelligence driven metrics. The computing system ranks the plurality of insights using one or more artificial intelligence techniques. The computing system generates a graphical user interface comprising the event data and at least one insight of the plurality of insights. The computing system causes a user device to display the graphical user interface.

### CROSS-REFERENCE TO RELATED APPLICATIONS

This application claims priority to U.S. Provisional Application Ser. No. 63/201,529, filed May 4, 2021, which is hereby incorporated by reference in its entirety.

### FIELD OF THE DISCLOSURE

The present disclosure generally relates to a sporting event console for delivering event information and artificial intelligence driven insights and a method of operating the same.

### BACKGROUND

In professional sports, commentators and platform providers continue to compete in delivering event information and insights to end users. Often, such process is driven by human operators that try to ingest the vast amount of information during the course of a game to deliver insights to end users.

### SUMMARY

In some embodiments, a method is disclosed herein. A computing system receives event data for a game. The computing system generates a plurality of artificial intelligence driven metrics based on the event data. The computing system generates a plurality of insights via one or more machine learning models based on the event data and the plurality of artificial intelligence driven metrics. The computing system ranks the plurality of insights using one or more artificial intelligence techniques. The computing system generates a graphical user interface comprising the event data and at least one insight of the plurality of insights. The computing system causes a user device to display the graphical user interface.

In some embodiments, a non-transitory computer readable medium is disclosed herein. The non-transitory computer readable medium includes one or more sequences of instructions, which, when executed by a processor, causes a computing system to perform operations. The operations include receiving, by the computing system, event data for a game. The operations further include generating, by the computing system, a plurality of artificial intelligence driven metrics based on the event data. The operations further include generating, by the computing system, a plurality of insights via one or more machine learning models based on the event data and the plurality of artificial intelligence driven metrics. The operations further include ranking, by the computing system, the plurality of insights using one or more artificial intelligence techniques. The operations further include generating, by the computing system, a graphical user interface comprising the event data and at least one insight of the plurality of insights. The operations further include causing, by the computing system, a user device to display the graphical user interface.

In some embodiments, a system is disclosed herein. The system includes a processor and a memory. The memory has programming instructions stored thereon, which, when executed by the processor, causes the system to perform operations. The operations include receiving event data for a game. The operations further include generating a plurality of artificial intelligence driven metrics based on the event data. The operations further include generating a plurality of insights via one or more machine learning models based on the event data and the plurality of artificial intelligence driven metrics. The operations further include ranking the plurality of insights using one or more artificial intelligence techniques. The operations further include generating a graphical user interface comprising the event data and at least one insight of the plurality of insights. The operations further include causing a user device to display the graphical user interface.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2A illustrates an exemplary graphical user interface, according to example embodiments.

FIG. 2B illustrates an exemplary graphical user interface, according to example embodiments.

FIG. 3A illustrates an exemplary graphical user interface, according to example embodiments.

FIG. 3B illustrates an exemplary graphical user interface, according to example embodiments.

FIG. 4A illustrates an exemplary graphical user interface, according to example embodiments.

FIG. 4B illustrates an exemplary graphical user interface, according to example embodiments.

FIG. 4C illustrates an exemplary graphical user interface, according to example embodiments.

FIG. 5A illustrates an exemplary graphical user interface, according to example embodiments.

FIG. 5B illustrates an exemplary graphical user interface, according to example embodiments.

FIG. 5C illustrates an exemplary graphical user interface, according to example embodiments.

FIG. 5D illustrates an exemplary graphical user interface, according to example embodiments.

FIG. 5E illustrates an exemplary graphical user interface, according to example embodiments.

FIG. 6A is a block diagram illustrating a computing device, according to example embodiments.

FIG. 6B is a block diagram illustrating a computing device, according to example embodiments.

FIG. 7 is a flow diagram illustrating a method of generating and presenting a machine learning generated insight, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

One or more techniques disclosed herein are generally directed to a system to generate, rank, and then recommend content to a user based on what the system thinks is the most relevant/interesting bit of content. In some embodiments, such rankings/insights may be used to value a possible advertisement spot or to sell the actual content delivered. In some embodiments, such ranking system may further be used to determine which artificial intelligence content (e.g., insights, statistics, etc.) to include with a visualization or overlay on a video/image.

While the present discussion is provided in the context of both soccer and basketball, those skilled in the art readily understand that such functionality may be extended to other sports.

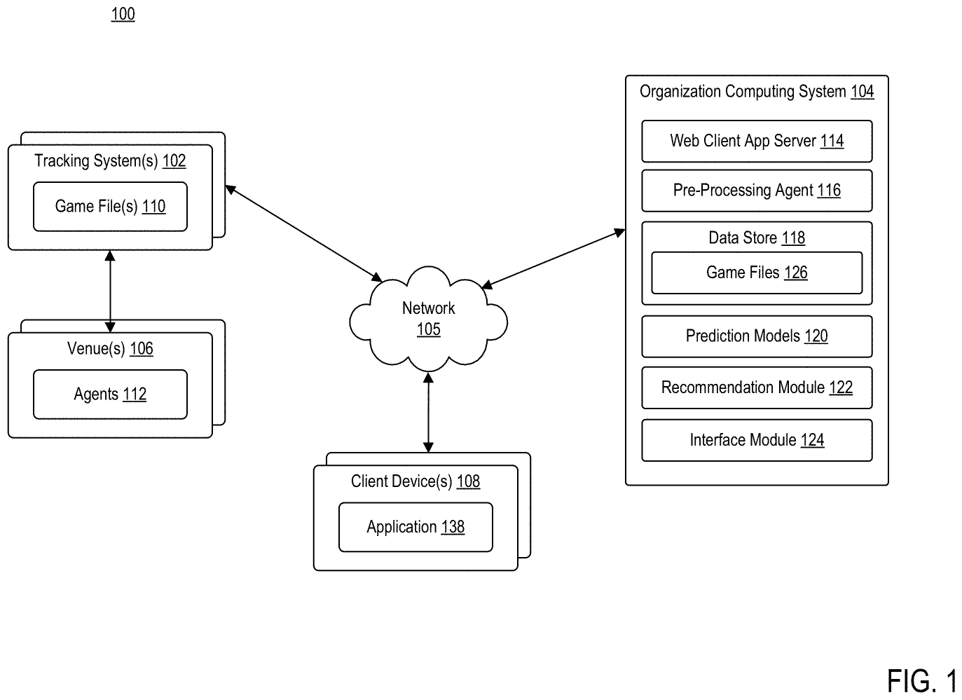

FIG. 1 is a block diagram illustrating a computing environment 100, according to example embodiments. Computing environment 100 may include tracking system 102, organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106. For example, venue 106 may be configured to host a sporting event that includes one or more agents 112. Tracking system 102 may be configured to record the motions of all agents (i.e., players) on the playing surface, as well as one or more other objects of relevance (e.g., ball, referees, etc.). In some embodiments, tracking system 102 may be an optically-based system using, for example, a plurality of fixed cameras. For example, a system of six stationary, calibrated cameras, which project the three-dimensional locations of players and the ball onto a two-dimensional overhead view of the court may be used. In some embodiments, tracking system 102 may be a radio-based system using, for example, radio frequency identification (RFID) tags worn by players or embedded in objects to be tracked. Generally, tracking system 102 may be configured to sample and record, at a high frame rate (e.g., 25 Hz). Tracking system 102 may be configured to store at least player identity and positional information (e.g., (x, y) position) for all agents and objects on the playing surface for each frame in a game file 110.

Game file 110 may be augmented with other event information corresponding to event data, such as, but not limited to, game event information (pass, made shot, turnover, etc.) and context information (current score, time remaining, etc.).

Tracking system 102 may be configured to communicate with organization computing system 104 via network 105. Organization computing system 104 may be configured to manage and analyze the data captured by tracking system 102. Organization computing system 104 may include at least a web client application server 114, a pre-processing agent 116, a data store 118, one or more prediction models 120, a recommendation module 122, and an interface module 124. Each of pre-processing agent 116, one or more prediction models 120, recommendation module 122, and interface module 124 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Data store 118 may be configured to store one or more game files 126. Each game file 126 may include spatial event data and non-spatial event data. For example, spatial event data may correspond to raw data captured from a particular game or event by tracking system 102. Non-spatial event data may correspond to one or more variables describing the events occurring in a particular match without associated spatial information. For example, non-spatial event data may correspond to each play-by-play event in a particular match. In some embodiments, non-spatial event data may be derived from spatial event data. For example, pre-processing agent 116 may be configured to parse the spatial event data to derive play-by-play information. In some embodiments, non-spatial event data may be derived independently from spatial event data. For example, an administrator or entity associated with organization computing system may analyze each match to generate such non-spatial event data. As such, for purposes of this application, event data may correspond to spatial event data and non-spatial event data.

In some embodiments, each game file 126 may further include the home and away team box scores. For example, the home and away teams' box scores may include the number of team assists, fouls, rebounds (e.g., offensive, defensive, total), steals, and turnovers at each time, t, during gameplay. In some embodiments, each game file 126 may further include a player box score. For example, the player box score may include the number of player assists, fouls, rebounds, shot attempts, points, free-throw attempts, free-throws made, blocks, turnovers, minutes played, plus/minus metric, game started, and the like. Although the above metrics are discussed with respect to basketball, those skilled in the art readily understand that the specific metrics may change based on sport. For example, in soccer, the home and away teams' box scores may include shot attempts, assists, crosses, shots, and the like.

Pre-processing agent 116 may be configured to process data retrieved from data store 118. For example, pre-processing agent 116 may be configured to generate one or more sets of information that may be used to train one or more prediction models 120.

Prediction models 120 may be representative of one or more prediction models utilized by an entity associated with organization computing system 104. For example, prediction models 120 may be representative of one or more prediction models and/or software tools currently available from STATS® Perform, headquartered in Chicago, Ill. In some embodiments, prediction models 120 may be representative of one or more prediction models associated with AutoSTATS artificial intelligence platform, commercially available from STATS® Perform. In some embodiments, prediction models 120 may be representative of one or more prediction models.

In some embodiments, predictions models 120 may include prediction engines configured to accurately model defensive behavior and its effect on attacking behavior, such as that disclosed in U.S. application Ser. No. 17/649,970, which is hereby incorporated by reference in its entirety.

In some embodiments, predictions models 120 may include prediction models configured to accurately model or classify a team's playing style or a player's playing style, such as that disclosed in U.S. application Ser. No. 16/870,170, which is hereby incorporated by reference in its entirety.

In some embodiments, predictions models 120 may include prediction models configured to accurately model a team's offensive or defensive alignment, such as that disclosed in U.S. application Ser. No. 16/254,128, which is hereby incorporated by reference in its entirety.

In some embodiments, predictions models 120 may include prediction models configured to accurately model a team's formation, such as that disclosed in U.S. application Ser. No. 17/303,361, which is hereby incorporated by reference in its entirety.

In some embodiments, predictions models 120 may include prediction models configured to generate macro predictions and/or micro predictions in sports, such as that disclosed in U.S. application Ser. No. 17/651,960, which is hereby incorporated by reference in its entirety. For example, one or more models configured to generate macro predictions such as, but not limited to, season simulation, or tournament simulation (i.e., predicting the outcome of a season/tournament). For example, one or more models configured to generate micro predictions such as, but not limited to, live-win-probability, final-score prediction (and/or final spread and score totals), 4th-Down-Bot/Go-For-two (e.g., American Football), player and team prop predictions (e.g., number of shots, goals, passes, etc.).

In some embodiments, predictions models 120 may include prediction models configured to accurately predict an outcome of an event or game, such as that disclosed in U.S. application Ser. No. 16/254,108, which is hereby incorporated by reference in its entirety.

In some embodiments, prediction models 120 may include prediction models configured to accurately predict an outcome of an event or game, such as that disclosed in U.S. application Ser. No. 16/254,088, which is hereby incorporated by reference in its entirety.

In some embodiments, prediction models 120 may include prediction models configured to accurately generate in-game insights, such as that disclosed in U.S. application Ser. No. 17/653,394, which is hereby incorporated by reference in its entirety.

In some embodiments, one or more prediction models 120 may include, but are not limited to a receiver model, a playing style model, a live-win prediction model, a transition model, a danger model, a goal-keeper model, and the like. For example, one or more prediction models 120 may include prediction models configured to generate quality or execution metrics, such as, but not limited to, expected goal value, expected pass value, possession value, and dangerous play detection. In another example, one or more prediction models 120 may include prediction models configured to generate event detection or semantic detection, such as, but are not limited to, formation change or counter-attack detection in soccer. More generally, prediction models 120 may be used to generate one or more AI metrics, based on the event data.

Using the one or more AI metrics, prediction models 120 may be configured to generate a plurality of insights about the game. An exemplary insight may include a statement that a player or team is over/under-performing relative to a career/season/tournament, and the like. Another exemplary insight may include a statement that identifies team level streaks (e.g., points, turnovers, rebounds, blocks, first downs, hits, doubles, goals, assists, etc.) and player-level streaks (e.g., points, turnovers, steals, assists, rebounds (offensive/defensive), catches, sacks, hits, etc.).

Recommendation module 122 may be configured to generate relevance metrics using one or more machine learning techniques to rank the importance of an insight. For example, recommendation module 122 may rank the importance of an insight in terms of a team winning the match, the importance in the context of the entire season, as well as the individual player contribution within the match and season using both team and player micro predictions (e.g., win-probability, team and player props, expected goal value, possession value, and the like) and team and player macro predictions (e.g., season simulation outputs). In some embodiments, recommendation module 122 may utilize the one or more AI metrics to generate the ranking. In some embodiments, recommendation module 122 may utilize a ranking function that recommends which content to promote to the user.

In some embodiments, the ranking of insights may include a content-based filtering approach. For example, recommendation module 122 may utilize a combination of relevance measures and a rule-based system to rank content.

In some embodiments, the ranking of insights may include a collaborative filtering approach, such as user-based feedback. For example, users may like or star which bits of content they want to utilize in a training phase. During the testing phase, recommendation module 122 may apply the learnt predictor to recommend content to the user. In some embodiments, to learn the predictor, the input feature may be the game-information, along with the generated relevance metrics. Recommendation module 122 may then utilize a supervised learning technique (such as Non-Negative Matrix Factorization and classifier, a deep learning model, a wide and deep model, etc.

In some embodiments, the ranking of insights may include user-generated rules (e.g., THUUZ™ smart Ratings).

In some embodiments, in addition to the ranking of insights, recommendation module 122 may be further used to generate a new combination of insights.

In some embodiments, in addition to the ranking of insights, recommendation module 122 may be further used to price a value of the insight for downstream purchasing.

Interface module 124 may be configured to generate one or more interfaces for presenting various insights to users. In some embodiments, interface module 124 may generate a live match console that aggregates tracking and event data, insights, and graphics into a single interface designed for sports producers, commentators, researchers/statisticians, website editors, social media managers, and the like. Utilizing recommendation module 122, interface module 124 may further provide users with a real-time (or near real-time) content stream of suggested content. In some embodiments, interface module 124 may further include chat functionality. For example, interface module 124 may utilize a smart assistant or a real-life assistant to supplement the live stream.

Interface module 124 may be further configured to generate a video portal. The video portal may include video content spanning several seasons of games and other associated content across sports. In some embodiments, such video portal may support, for example, AI features for search, recommendation and alerting. In some embodiments, such video portal may support, for example, video editing and social media publishing. In some embodiments, such video portal may support overlay data graphics. In some embodiments, such video portal may support, for example, the purchase of video clips. For example, video clips the video portal may support non-fungible tokens (NFTs) of video clips.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 138. Application 138 may be representative of a web browser that allows access to a website or a stand-alone application. Client device 108 may access application 138 to access one or more functionalities of organization computing system 104. Client device 108 may communicate over network 105 to request a webpage, for example, from web client application server 114 of organization computing system 104. For example, client device 108 may be configured to execute application 138 to access various portals and/or interfaces generated by organization computing system 104.

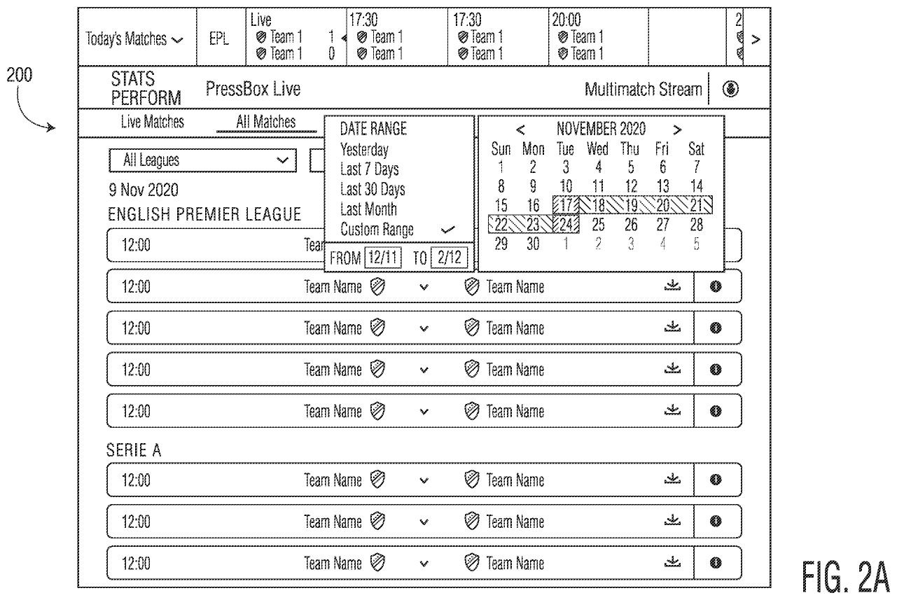

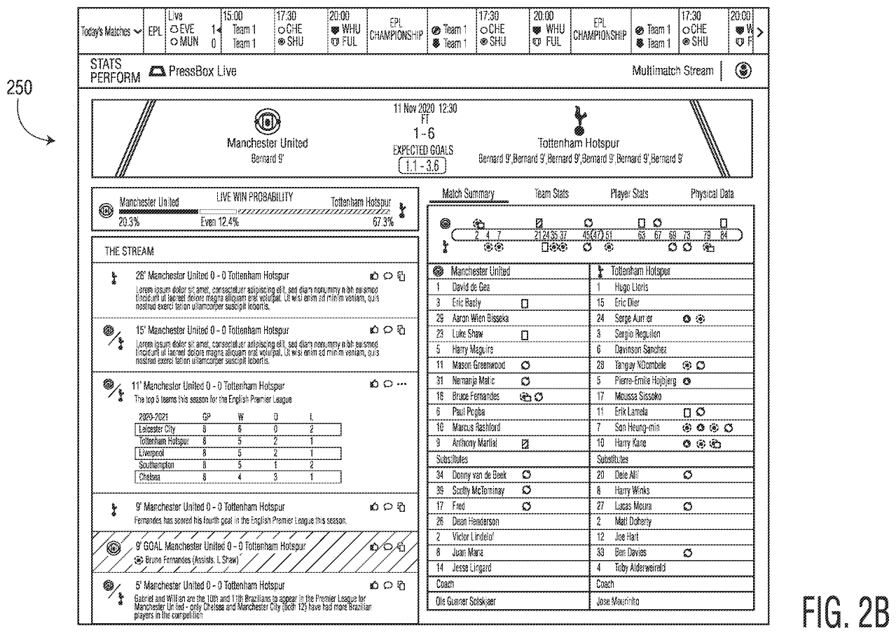

FIG. 2A illustrates an exemplary graphical user interface (GUI) 200, according to example embodiments. As shown, GUI 200 provides a platform or portal for delivering data, insights, video, news, and/or graphics to end users. For example, via GUI 200, a user can select a game from a variety of leagues across a variety of date ranges.

FIG. 2B illustrates an exemplary graphical user interface (GUI) 250, according to example embodiments. As shown, GUI 250 provides a platform or portal for delivering data, insights, video, news, and/or graphics to end users. For example, via GUI 250, a user can view details regarding a specific game, such as, but not limited to, generated insights as well as up to date game or event data.

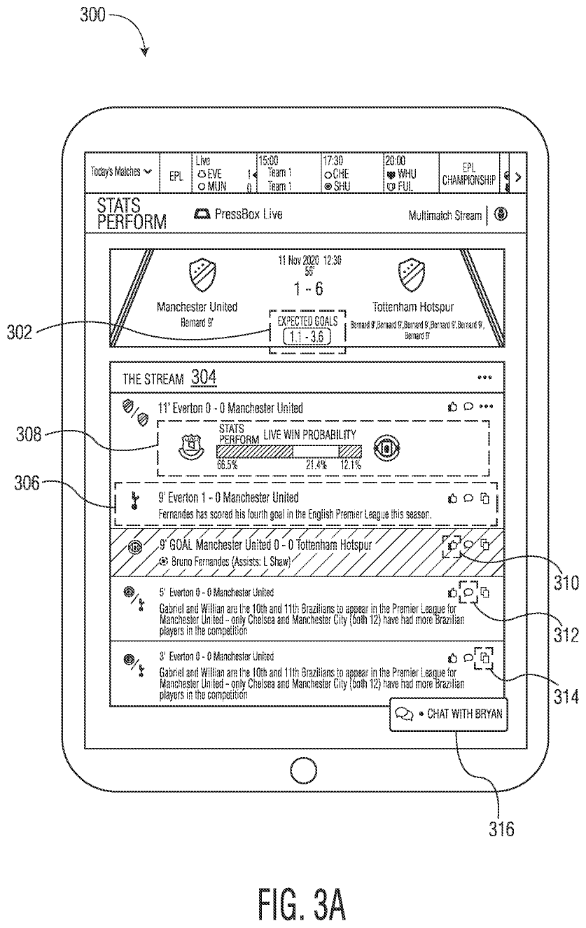

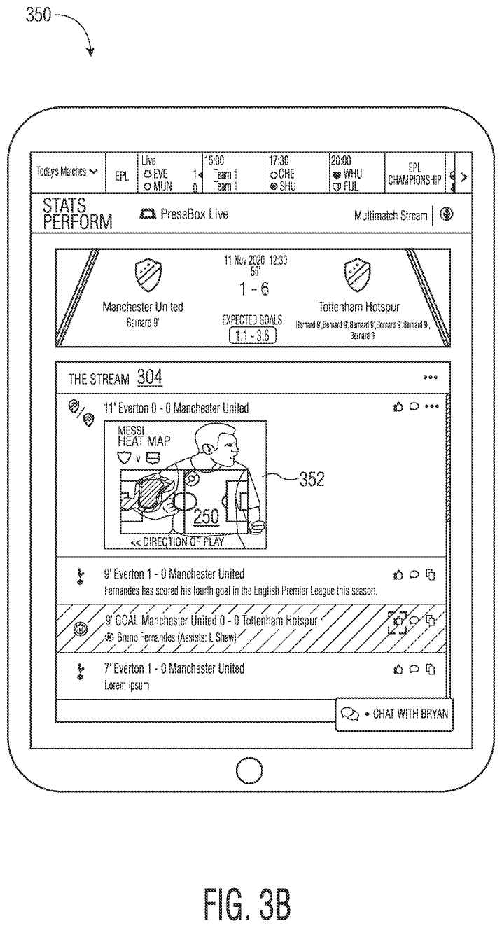

FIG. 3A illustrates an exemplary graphical user interface (GUI) 300, according to example embodiments. As shown, GUI 300 provides a platform or portal for delivering data, insights, video, news, and/or graphics to end users. For example, via GUI 300, a user can view details regarding a specific game, such as, but not limited to, generated insights as well as up to date game or event data.

GUI 300 may include one or more graphical elements. In some embodiments, GUI 300 may include graphical element 302. Graphical element 302 may correspond to a first generated metric. For example, as shown, graphical element 302 may correspond to an expected goals metric, generated by one or more prediction models 120.

In some embodiments, GUI 300 may include a content stream 304. Content stream 304 may provide a real-time (or near real-time) automated stream of content. As shown, content stream 304 may include one or more graphical elements. In some embodiments, content stream 304 may include a plurality of graphical elements 306. Each graphical element 306 may correspond to a live generated insight. In some embodiment, each insight is generated in real-time or near real-time as the event is progressing. In some embodiment, an insight may be generated after the event or game has ended to provide a summary or post-game insight. In some embodiments, each insight may include various data associated therewith. For example, content stream 304 may include graphical element 308. Graphical element 308 may provide a live win probability associated with a current state of the game, as generated by one or more prediction models 120.

In some embodiments, GUI 300 may support interactive functionality. For example, as shown, each generated insight may include one or more graphical elements 310-314 associated therewith. Graphical element 310 may correspond to a like button that may be used to create a feedback loop and enable content personalization to the user. Graphical element 312 may correspond to a publish option, by which the user may publish an insight to a social media platform and/or third-party broadcast graphics software. Graphical element 314 may correspond to a download button. The download button allows a user to access reports, commentator notes, or other insights while offline.

In some embodiments, GUI 300 may further include graphical element 316. Graphical element 316 may allow a user to access functionality of an assistant. In some embodiments, the assistant may be a smart assistant. In some embodiments, the assistant may be another user or administrator sitting at a computing terminal.

FIG. 3B illustrates an exemplary graphical user interface (GUI) 350, according to example embodiments. As shown, GUI 350 provides a platform or portal for delivering data, insights, video, news, and/or graphics to end users. For example, via GUI 350, a user can view details regarding a specific game, such as, but not limited to, generated insights as well as up to date game or event data. As shown, GUI 350 may be a continuation of GUI 300 illustrated in FIG. 3A above, with an additional insight generated.

As shown, GUI 350 may include graphical element 352 in content stream 304. Graphical element 352 may correspond to a graphic generated by a third party-system, such as OPTA Graphics. Such functionality may allow customers to publish insights and graphics to social media.

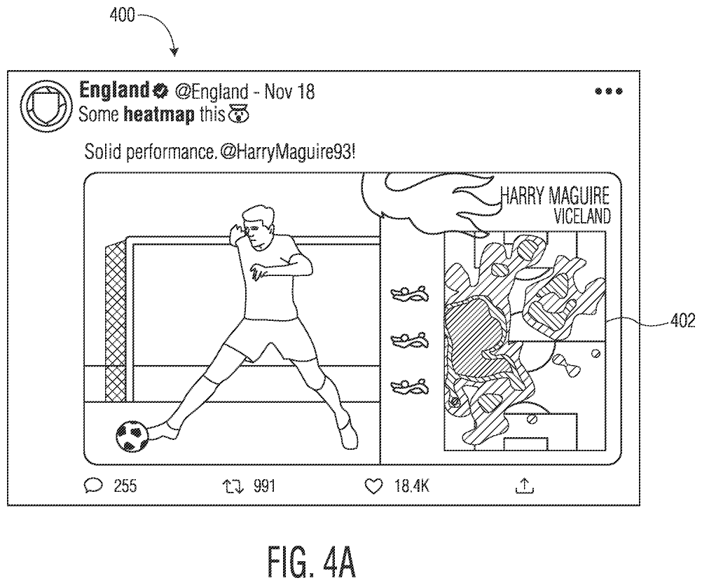

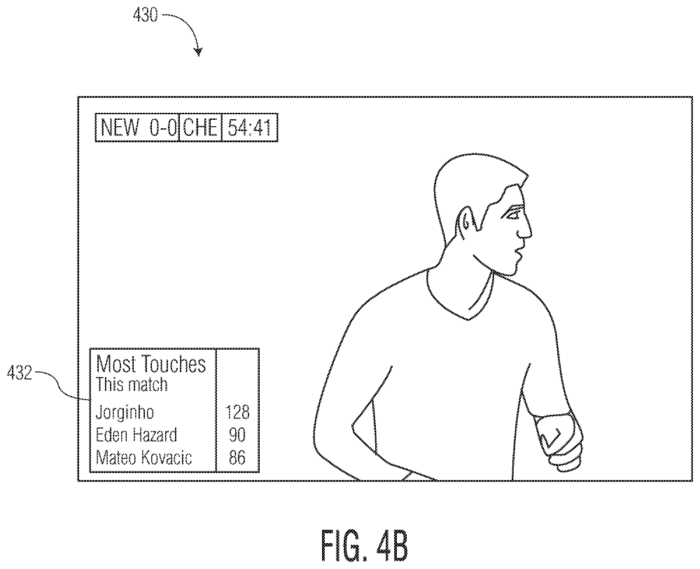

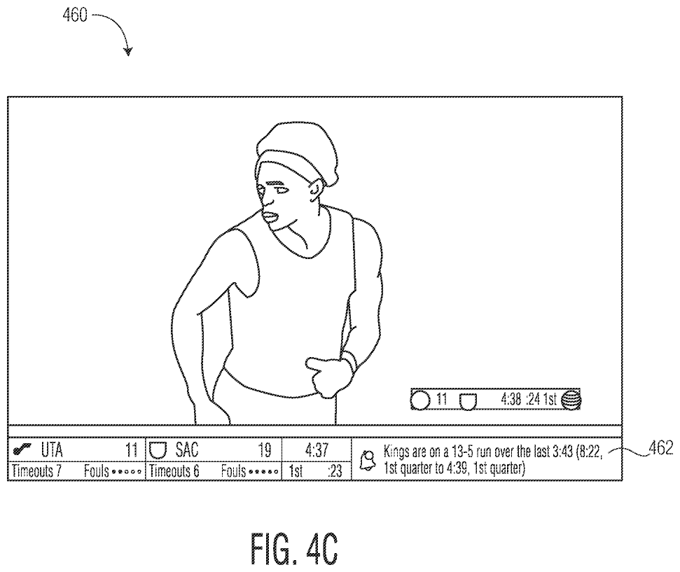

FIG. 4A illustrates an exemplary graphical user interface (GUI) 400, according to example embodiments. GUI 400 may correspond to an example social media post following a user selecting graphical element 312 corresponding to the publishing of an insight via a social media platform. As shown, GUI 400 may correspond to a tweet posted on Twitter. GUI 400 may include graphical element 402. Graphical element 402 may correspond to an insight generated by one or more prediction models 120.

FIG. 4B illustrates an exemplary graphical user interface (GUI) 430, according to example embodiments. GUI 430 may correspond to an example integration with a third-party broadcast software following a user selecting graphical element 312 corresponding to the publishing of an insight via a social media platform. As shown, GUI 430 may correspond to broadcast or on-demand feed of the game illustrated in GUIs 300 and 350 described above. The broadcast or on-demand feed may include graphical element 432. Graphical element 432 may correspond to an insight generated by one or more prediction models 120 and embedded into one or more video frames of the game.

FIG. 4C illustrates an exemplary graphical user interface (GUI) 460, according to example embodiments. GUI 460 may correspond to an example integration with a third-party broadcast software following a user selecting graphical element 312 corresponding to the publishing of an insight via a social media platform. As shown, GUI 460 may correspond to broadcast or on-demand feed of the game illustrated in GUIs 300 and 350 described above. The broadcast or on-demand feed may include graphical element 462. Graphical element 462 may correspond to an insight generated by one or more prediction models 120 and embedded into one or more video frames of the game.

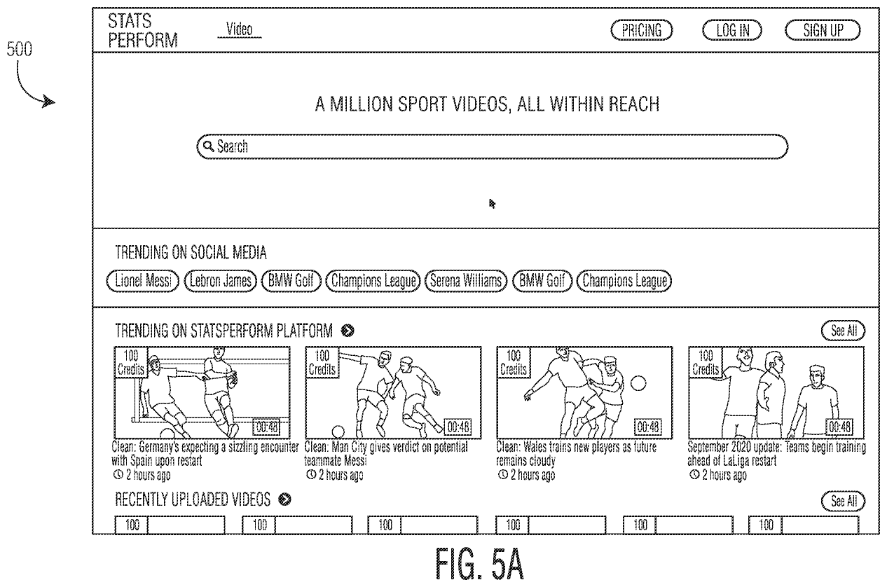

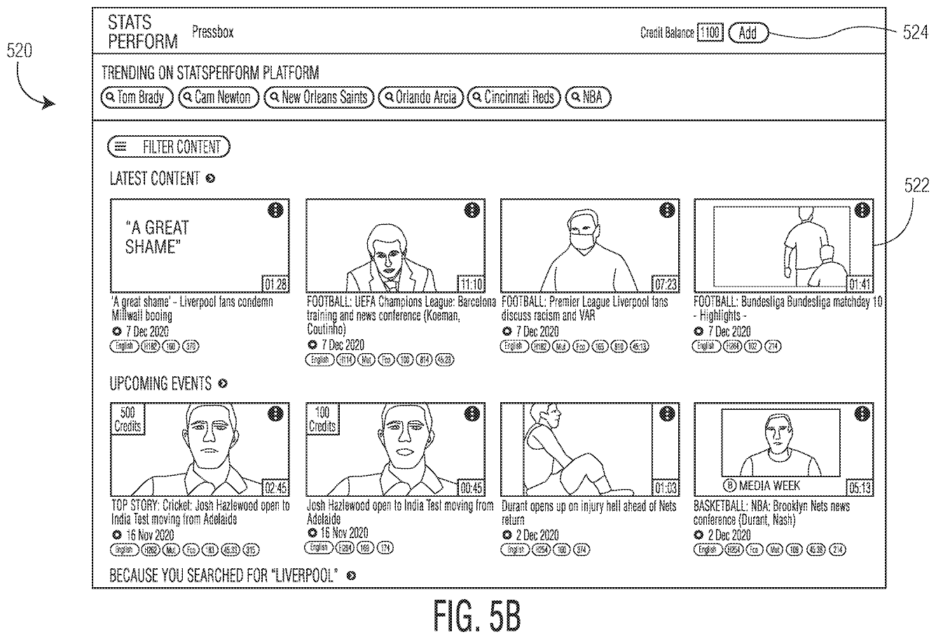

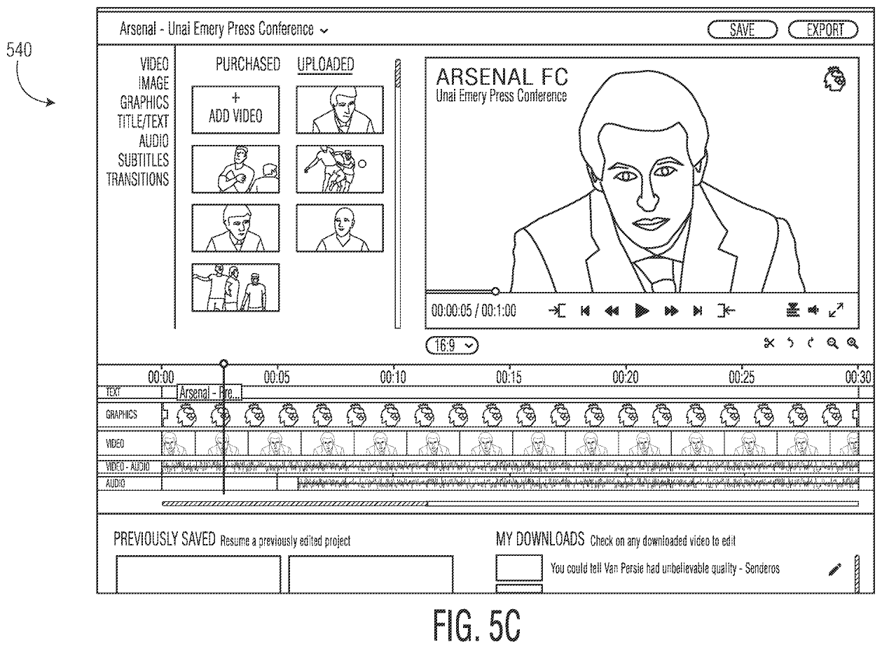

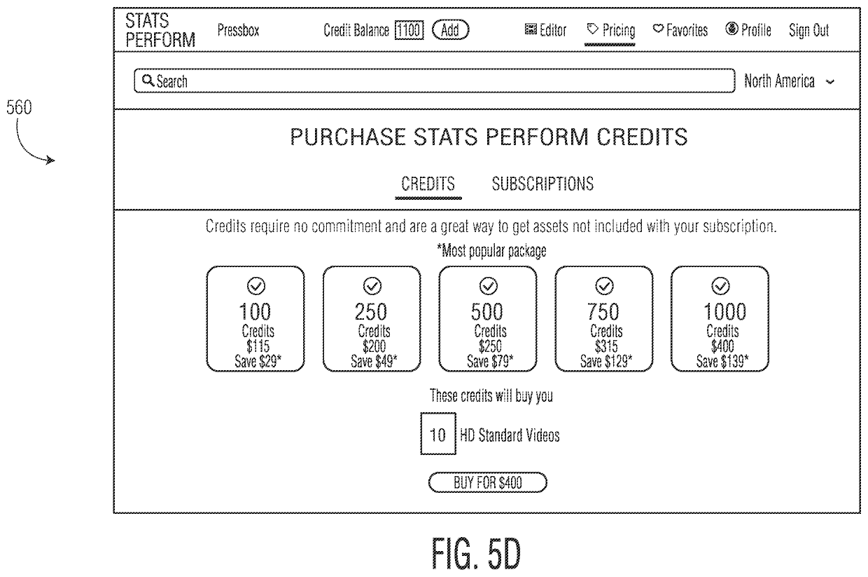

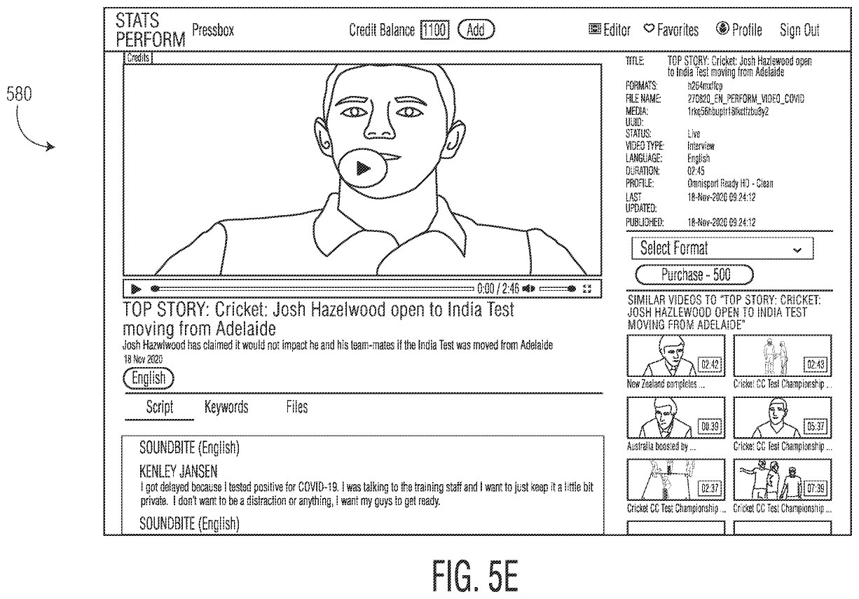

FIG. 5A illustrates an exemplary graphical user interface (GUI) 500, according to example embodiments. GUI 500 may correspond to a video portal (e.g., PressBox Video) generated by interface module 124. GUI 500 may be illustrative of a portal through which a user can access and purchase content associated with organization computing system 104. In some embodiments, a user may edit and publish directly from the platform.

FIG. 5B illustrates an exemplary graphical user interface (GUI) 520, according to example embodiments. GUI 520 may correspond to a video portal (e.g., PressBox Video) generated by interface module 124. GUI 520 may be illustrative of a portal through which a user can access and purchase content associated with organization computing system 104. GUI 520 may correspond to a GUI following receipt of a search query via GUI 500 described above. As shown, GUI 520 may include one or more graphical elements 522. Each graphical element 522 may correspond to a video that satisfied the search query. In some embodiments, GUI 520 may include graphical element 524. Graphical element 524 may allow a user to toggle on functionality related to automated alerting of new client-relevant content. In other words, once a new video or clip exists that satisfies the user's query, the user may be notified (e.g., push notification, SMS message, email, etc.) that a new clip is available.

FIG. 5C illustrates an exemplary graphical user interface (GUI) 540, according to example embodiments. GUI 540 may correspond to a video editing page generated by interface module 124. For example, when a user selects a video or clip, such as those shown in GUI 500 and 520, a user may be provided with a video editing page. Via GUI 520, a user may be presented with video editing and subtitling tools that may allow a user to brand, translate, crop and publish video directly from the video portal.

FIG. 5D illustrates an exemplary graphical user interface (GUI) 560, according to example embodiments. GUI 560 may correspond to a credit purchase page of the video portal generated by interface module 124. GUI 560 may be representative of a self-service tool for new user to purchase clips individually.

FIG. 5E illustrates an exemplary graphical user interface (GUI) 580, according to example embodiments. GUI 580 may correspond to a video or clip purchasing page generated by interface module 124. For example, when a user selects a video or clip to purchase, such as those shown in GUI 500 and 520, a user may be provided with a video or clip purchasing page. Via GUI 580, a user may be provided with information about the video or clip, as well as the option to purchase the video or clip in a variety of formats. In some embodiments, the user may be provided with the option for AI-driven subtitles and transcription in multiple languages.

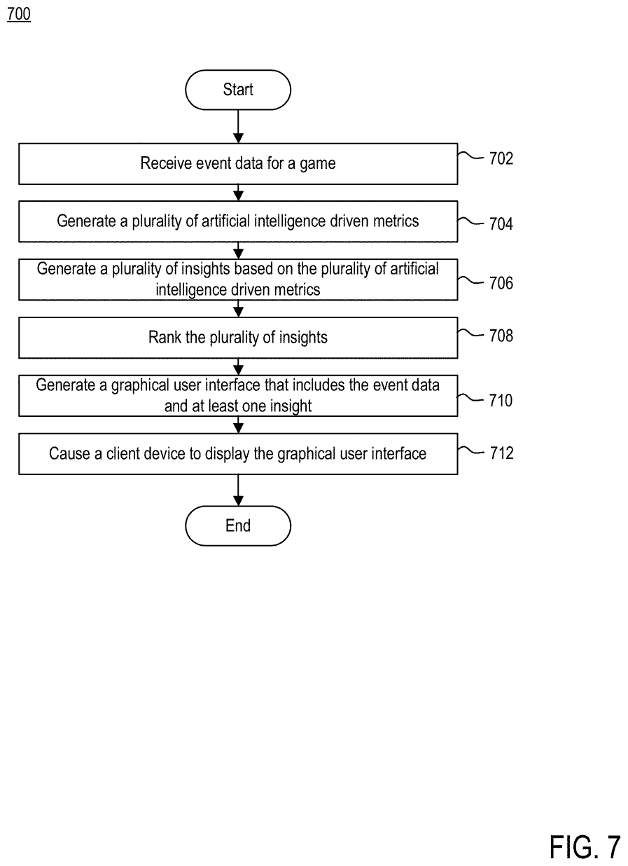

FIG. 7 is a flow diagram illustrating a method 700 of generating and presenting a machine learning generated insight, according to example embodiments. Method 700 may begin at step 702.

At step 702, organization computing system 104 may receive event data for a game. In some embodiments, event data may include, but is not limited to, game event information (pass, made shot, turnover, etc.) and context information (current score, time remaining, etc.). In some embodiments, event data may include spatial event data and non-spatial event data. For example, spatial event data may correspond to raw data captured from a particular game or event by tracking system 102. Non-spatial event data may correspond to one or more variables describing the events occurring in a particular match without associated spatial information. For example, non-spatial event data may correspond to each play-by-play event in a particular match. In some embodiments, non-spatial event data may be derived from spatial event data. For example, pre-processing agent 116 may be configured to parse the spatial event data to derive play-by-play information. In some embodiments, non-spatial event data may be derived independently from spatial event data. For example, an administrator or entity associated with organization computing system may analyze each match to generate such non-spatial event data. As such, for purposes of this application, event data may correspond to spatial event data and non-spatial event data.

At step 704, organization computing system 104 may generate a plurality of artificial intelligence driven metrics based on the event data. For example, prediction models 120 may be trained to generate a plurality of artificial intelligence driven metrics based on the event data.

At step 706, organization computing system 104 may generate a plurality of insights based on the artificial intelligence driven metrics. For example, prediction models 120 may generate a plurality of insights via one or more machine learning models based on the event data and the plurality of artificial intelligence driven metrics. An exemplary insight may include a statement that a player or team is over/under-performing relative to a career/season/tournament, and the like. Another exemplary insight may include a statement that identifies team level streaks (e.g., points, turnovers, rebounds, blocks, first downs, hits, doubles, goals, assists, etc.) and player-level streaks (e.g., points, turnovers, steals, assists, rebounds (offensive/defensive), catches, sacks, hits, etc.).

At step 708, organization computing system 104 may rank the plurality of insights using one or more artificial intelligence techniques. For example, recommendation module 122 may rank the importance of an insight in terms of a team winning the match, the importance in the context of the entire season, as well as the individual player contribution within the match and season using both team and player micro predictions (e.g., win-probability, team and player props, expected goal value, possession value, and the like) and team and player macro predictions (e.g., season simulation outputs). In some embodiments, recommendation module 122 may utilize the one or more AI metrics to generate the ranking. In some embodiments, recommendation module 122 may utilize a ranking function that recommends which content to promote to the user.

In some embodiments, the ranking of insights may include a content-based filtering approach. For example, recommendation module 122 may utilize a combination of relevance measures and a rule-based system to rank content.

In some embodiments, the ranking of insights may include a collaborative filtering approach, such as user-based feedback. For example, users may like or star which bits of content they want to utilize in a training phase. During the testing phase, recommendation module 122 may apply the learnt predictor to recommend content to the user. In some embodiments, to learn the predictor, the input feature may be the game-information, along with the generated relevance metrics. Recommendation module 122 may then utilize a supervised learning technique (such as Non-Negative Matrix Factorization and classifier, a deep learning model, a wide and deep model, etc.

In some embodiments, the ranking of insights may include user-generated rules (e.g., THUUZ™ smart Ratings).

At step 710, organization computing system 104 may generate a graphical user interface that includes the event data and at least one insight of the plurality of insights. For example, interface module 124 may generate a graphical user interface that includes aggregated tracking and event data and at least one insight of the plurality of insights.

At step 712, organization computing system 104 may cause a client device to display the graphical user interface. For example, organization computing system 104 may provide the graphical user interface to client device 108 for display via application 138.

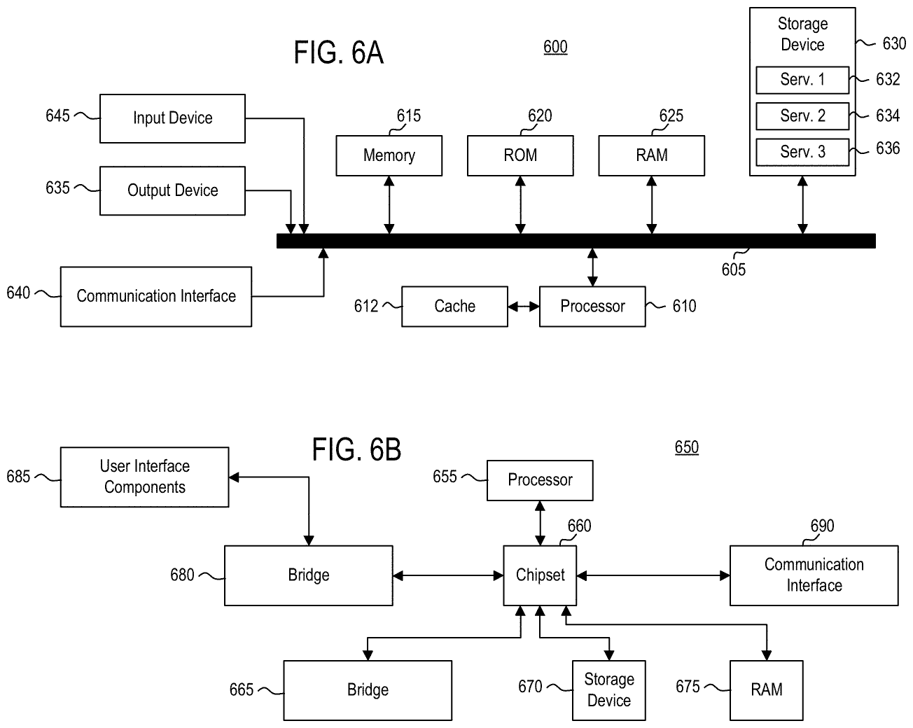

FIG. 6A illustrates a system bus architecture of computing system 600, according to example embodiments. System 600 may be representative of at least a portion of organization computing system 104. One or more components of system 600 may be in electrical communication with each other using a bus 605. System 600 may include a processing unit (CPU or processor) 610 and a system bus 605 that couples various system components including the system memory 615, such as read only memory (ROM) 620 and random access memory (RAM) 625, to processor 610. System 600 may include a cache of high-speed memory connected directly with, in close proximity to, or integrated as part of processor 610. System 600 may copy data from memory 615 and/or storage device 630 to cache 612 for quick access by processor 610. In this way, cache 612 may provide a performance boost that avoids processor 610 delays while waiting for data. These and other modules may control or be configured to control processor 610 to perform various actions. Other system memory 615 may be available for use as well. Memory 615 may include multiple different types of memory with different performance characteristics. Processor 610 may include any general purpose processor and a hardware module or software module, such as service 1 632, service 2 634, and service 3 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction with the computing system 600, an input device 645 may represent any number of input mechanisms, such as a microphone for speech, a touch-sensitive screen for gesture or graphical input, keyboard, mouse, motion input, speech and so forth. An output device 635 may also be one or more of a number of output mechanisms known to those of skill in the art. In some instances, multimodal systems may enable a user to provide multiple types of input to communicate with computing system 600. Communications interface 640 may generally govern and manage the user input and system output. There is no restriction on operating on any particular hardware arrangement and therefore the basic features here may easily be substituted for improved hardware or firmware arrangements as they are developed.

Storage device 630 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 625, read only memory (ROM) 620, and hybrids thereof.

Storage device 630 may include services 632, 634, and 636 for controlling the processor 610. Other hardware or software modules are contemplated. Storage device 630 may be connected to system bus 605. In one aspect, a hardware module that performs a particular function may include the software component stored in a computer-readable medium in connection with the necessary hardware components, such as processor 610, bus 605, output device 635 (e.g., display), and so forth, to carry out the function.

FIG. 6B illustrates a computer system 650 having a chipset architecture that may represent at least a portion of organization computing system 104. Computer system 650 may be an example of computer hardware, software, and firmware that may be used to implement the disclosed technology. System 650 may include a processor 655, representative of any number of physically and/or logically distinct resources capable of executing software, firmware, and hardware configured to perform identified computations. Processor 655 may communicate with a chipset 660 that may control input to and output from processor 655. In this example, chipset 660 outputs information to output 665, such as a display, and may read and write information to storage device 670, which may include magnetic media, and solid state media, for example. Chipset 660 may also read data from and write data to storage device 675 (e.g., RAM). A bridge 680 for interfacing with a variety of user interface components 685 may be provided for interfacing with chipset 660. Such user interface components 685 may include a keyboard, a microphone, touch detection and processing circuitry, a pointing device, such as a mouse, and so on. In general, inputs to system 650 may come from any of a variety of sources, machine generated and/or human generated.

Chipset 660 may also interface with one or more communication interfaces 690 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 655 analyzing data stored in storage device 670 or storage device 675. Further, the machine may receive inputs from a user through user interface components 685 and execute appropriate functions, such as browsing functions by interpreting these inputs using processor 655.

It may be appreciated that example systems 600 and 650 may have more than one processor 610 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed:

1. A method, comprising:
receiving, by a computing system, event data for a game;
generating, by the computing system, a plurality of artificial intelligence driven metrics based on the event data;
generating, by the computing system, a plurality of insights via one or more machine learning models based on the event data and the plurality of artificial intelligence driven metrics;
ranking, by the computing system, the plurality of insights using one or more artificial intelligence techniques;
generating, by the computing system, a graphical user interface comprising the event data and at least one insight of the plurality of insights; and
causing, by the computing system, a user device to display the graphical user interface.

2. The method of claim 1, further comprising:
generating, by the computing system, a combination of insights based on the generated plurality of insights and the ranking of the plurality of insights.

3. The method of claim 1, further comprising:
pricing, by the computing system, each insight of the plurality of generated insights.

4. The method of claim 1, wherein the event data comprises (x,y) coordinates of players within the game and the game context data.

5. The method of claim 1, wherein ranking, by the computing system, the plurality of insights using the one or more artificial intelligence techniques comprises:
ranking the plurality of insights based on learned preferences of end users.

6. The method of claim 1, wherein generating, by the computing system, the graphical user interface comprising the event data and at least one insight of the plurality of insights comprises:
embedding the at least one insight of the plurality of insights within the event data to provide context for the event data.

7. The method of claim 1, wherein the graphical user interface corresponds to a social media post comprising the event data and the at least one insight.

8. A non-transitory computer readable medium comprising one or more sequences of instructions, which, when executed by a processor, causes a computing system to perform one or more operations comprising:
receiving, by the computing system, event data for a game;
generating, by the computing system, a plurality of artificial intelligence driven metrics based on the event data;
generating, by the computing system, a plurality of insights via one or more machine learning models based on the event data and the plurality of artificial intelligence driven metrics;
ranking, by the computing system, the plurality of insights using one or more artificial intelligence techniques;
generating, by the computing system, a graphical user interface comprising the event data and at least one insight of the plurality of insights; and
causing, by the computing system, a user device to display the graphical user interface.

9. The non-transitory computer readable medium of claim 8, further comprising:
generating, by the computing system, a combination of insights based on the generated plurality of insights and the ranking of the plurality of insights.

10. The non-transitory computer readable medium of claim 8, further comprising:
pricing, by the computing system, each insight of the plurality of generated insights.

11. The non-transitory computer readable medium of claim 8, wherein the event data comprises (x,y) coordinates of players within the game and game context data.

12. The non-transitory computer readable medium of claim 8, wherein ranking, by the computing system, the plurality of insights using the one or more artificial intelligence techniques comprises:
ranking the plurality of insights based on learned preferences of end users.

13. The non-transitory computer readable medium of claim 8, wherein generating, by the computing system, the graphical user interface comprising the event data and at least one insight of the plurality of insights comprises:
embedding the at least one insight of the plurality of insights within the event data to provide context for the event data.

14. The non-transitory computer readable medium of claim 8, wherein the graphical user interface corresponds to a social media post comprising the event data and the at least one insight.

15. A system comprising:
a processor; and
a memory having programming instructions stored thereon, which, when executed by the processor, causes the system to perform operations comprising:
receiving event data for a game;
generating a plurality of artificial intelligence driven metrics based on the event data;
generating a plurality of insights via one or more machine learning models based on the event data and the plurality of artificial intelligence driven metrics;
ranking the plurality of insights using one or more artificial intelligence techniques;
generating a graphical user interface comprising the event data and at least one insight of the plurality of insights; and
causing a user device to display the graphical user interface.

16. The system of claim 15, wherein the operations further comprise:
generating a combination of insights based on the generated plurality of insights and the ranking of the plurality of insights.

17. The system of claim 15, wherein the operations further comprise:
pricing each insight of the plurality of generated insights.

18. The system of claim 15, wherein ranking the plurality of insights using the one or more artificial intelligence techniques comprises:
ranking the plurality of insights based on learned preferences of end users.

19. The system of claim 15, wherein generating the graphical user interface comprising the event data and at least one insight of the plurality of insights comprises:
embedding the at least one insight of the plurality of insights within the event data to provide context for the event data.

20. The system of claim 15, wherein the graphical user interface corresponds to a social media post comprising the event data and the at least one insight.
